(19) United States
(12) Patent Application Publication
(10) Pub. No.: US 2025/0229245 A1
(43) Pub. Date: Jul. 17, 2025

(54) PURGE CLEANING COMPOSITION FOR POLYMER REMOVAL IN LOW DENSITY POLYETHYLENE

(71) Applicant: Basell Polyolefine GmbH, Wesseling (DE)

(72) Inventors: Allen L. Brown, Pearland, TX (US); Nathan D. Brewer, Davenport, IA (US); Dominik Wagner, Wesseling (DE); Robin Dursun, Roesrath (DE)

(73) Assignee: Basell Polyolefine GmbH, Wesseling (DE)

(21) Appl. No.: 19/024,539

(22) Filed: Jan. 16, 2025

Related U.S. Application Data
(60) Provisional application No. 63/621,744, filed on Jan. 17, 2024.

(51) Int. Cl. B01J 19/00; B01J 19/06; B08B 9/032; C08F 10/02; C11D 7/50

(52) U.S. Cl. CPC B01J 19/002; B01J 19/06; B08B 9/0328; C08F 10/02; C11D 7/5027; B01J 2219/00225; B01J 2219/00247; B08B 2209/032

(57) ABSTRACT

The disclosure provides methods for removing polymeric fouling on process equipment during low density polyethylene manufacture. A purge cleaning composition with ethylene gas containing at least one C3+ hydrocarbon alkene for a period of time is used to remove polymer build-up in at least one location in the polymerization plant, such as, without limitation, the reactor or in tubing between a reactor and a pre-heater or between a cooler and a preheater.

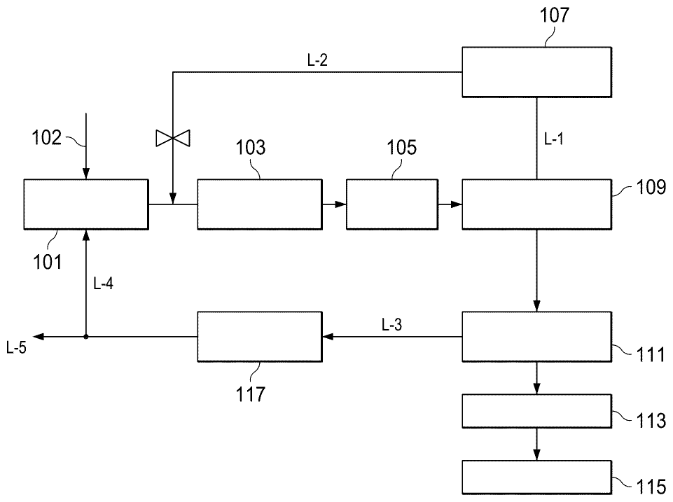

### PRIOR RELATED APPLICATIONS

This application claims the benefit of priority to U.S. Provisional Application No. 63/621,744, filed on Jan. 17, 2024, which is incorporated here by reference in its entirety.

### FEDERALLY SPONSORED RESEARCH STATEMENT

Not applicable.

### FIELD OF THE DISCLOSURE

The disclosure generally relates to removing polymer fouling from inside piping and other equipment in a polyethylene production process using a purge cleaning composition.

### BACKGROUND OF THE DISCLOSURE

Low density polyethylene (LDPE, 0.915-0.925 g/cm³) is one of the most commonly used and commercially important plastic due to its many favorable properties. LDPE is soft, flexible, lightweight, corrosion resistant and tough. It is used in a variety of applications including food packaging, shopping bags and liners, irrigation pipes, floor tiles, plastic furniture, etc. LDPE is characterized by its branching structure and contains statistically distributed short and long chain branches. High density polyethylene (HDPE, 0.94-0.96 g/cm³), by contrast, has little branching, which gives it a crystalline structure and its higher density. Medium density polyethylene (MDPE, 0.925-0.94 g/cm³) has an intermediate density and structure.

LDPE is produced by a free radical polymerization of ethylene gas reaction in a high-pressure process. A typical process for the production of LDPE consists of five operations—compression of ethylene gas, polymerization reaction, separation of gases, extrusion, and storage and packaging. LDPE production generally consist of systems with long pipes (1-3 km) with small inner diameters (5-10 cm) and thick reactor walls (2-5 cm) that are separated into several reaction and cooling zones. Two different continuously operated high-pressure reactors-autoclave and tubular reactors—are used for the polymerization reaction.

During the polymerization reaction, unwanted polymer may deposit on heat transfer surfaces, pipes and reactors. This deposition is called “polymer fouling.” The fouled equipment part is typically removed, cleaned, and then reinstated for operation. Thus, fouling in a polymerization plant is highly undesirable as it reduces the overall production efficiency of operation, causes energy losses due to lower thermal efficiency, and poses huge safety concerns. Increased fouling levels also result in poorer product quality of the polymer produced. Deposit build-up and fouling in a LDPE production facility can occur at various sections including, but not limited to compressors, coolers, reactor, separator, and in any piping that connects all these systems.

Traditional methods for removing polymer fouling include chemical treatment to dissolve deposits, or physical methods, such as hydroblasting, to remove deposits. Chemical treatment involves circulating a solvent for a period of time to dissolve polymer deposits, and the solvent may be recovered and reused in some instances. U.S. Pat. No. 6,644,326, for example, discusses dissolving polymeric fouling by circulating a high boiling aromatic solvent with low vapor pressure through a reactor without dismantling the equipment. Temperatures are quite high (500° F.), although pressures are quite low (50 psig). Earlier methods used hot ethylene without initiator for polymer defouling.

Although chemical treatment is reasonably effective in defouling, it is expensive to execute and creates significant safety burden on the operators. Handling flammable solvent at high temperatures requires extreme safety measures, operator supervision and robust spill control measures. Recycling and reuse of solvent are also not straightforward as the facility require additional flash separation systems and fittings for solvent recovery.

The mechanical treatment known as hydroblasting is a high-pressure cleaning method involving sending a jet of water through a nozzle at a fouled surface using very high pressure. The pressure ranges for hydroblasting are about 14,000-18,000 psig or preferably more. Although effective in removing fouling, hydroblasting is a mechanically intensive method as it requires decommissioning of equipment, and after removal of deposits, complete drying of all parts before re-commissioning. Significant time and expenses are involved in such an operation, and thus it cannot be used frequently.

Thus, what is needed in the art are new methods for defouling a polymer production facility. The new method should be cost effective, safe, less labor intensive, less time consuming, and require lower infrastructure costs. The ideal method would cause no harm to the equipment, would be available at the production facility, thus reducing the need to decommission equipment and send parts offsite for removal of deposits, and be safe and reliable. Such a method could have a wide-ranging application in all kinds of polymer plants, including those with all reactor types-from autoclaves to tubular reactors. The present disclosure addresses one or more of these needs.

### SUMMARY OF THE DISCLOSURE

Described herein is a method for removing polymer fouling in equipment and piping of polyethylene (PE) production plant inside the battery limits using a purge cleaning composition having a C3+ alkene.

In general, the presently disclosed method involves removal of polymeric deposits on surfaces and walls of equipment and lines in a PE production plant by halting PE production and circulating a purge cleaning composition comprising ethylene gas having a C3+ hydrocarbon containing at least one double bond (herein after, “a C3+ alkene”) at a concentration of about 1-6 mole %, for 2-6 hours through the equipment. Fouled equipment will be at a pressure range of about 3,000 to 25,000 psig, and temperature of about 175-300° F. (˜79-148° C.) during the cleaning process to enable removal of the deposits. Once the fouled equipment or piping is cleaned, the system is brought back online, with little to no loss in production.

The entire plant may be flushed with the purge cleaning composition, or just portions thereof, as needed. In some embodiments, the purge cleaning composition is circulated throughout the entire PE production plant, with the defouling occurring in locations with sufficient pressure and temperature, and not harming other equipment or lines otherwise.

The site(s), or locations, of fouling can be identified by monitoring gas flow, differential pressure, temperature, or even by physical inspection in some instances. For example, if the site of deposition is inside a feed line connecting a gas compressor to a reactor, the gas flow rate to the reactor will be low. In examples where the polymeric fouling occurs in the reactor itself, pressure difference at various zones of the reactors will be observed. Deposit build-up increases the pressure in a zone and may reduce heat transfer, and thus an increased pressure differential or change in temperature may be indicative of fouling. In other examples, the polymer fouling is determined by the significant reduction in the output from the reactor, leading to shut down of the plant and physical inspection to identify site of fouling. The purge cleaning composition is able to remove at least 75%, 80%, 90% or about 100% of the polymer fouling so that the locations can return to at least 75% or more of their original, pre-fouling operating conditions.

It is unexpected that polymeric deposits can be removed by a cleaning composition with an C3+ alkene, and the mechanism is unknown. Without being bound by any theory, we speculate that the alkene combined with free radicals in the system to cleave the PE polymer deposits (e.g. LDPE, MDPE), resulting in shorter chain polymers. These shorter chain polymers may swell and disengage from surfaces including wall of the pipes, compressors, and reactors. The shorter chain polymers are dissolved in the flush gas, allowing them to be removed in the various separators designed to separate polymers from gas. Removal of HDPE polymer fouling is expected to be amendable to this method as well, though testing will be needed to confirm as HDPE lacks much of the branching found in other types of PE.

Most of the benefit of the presently described flush process is for the high-pressure zones of the PE production plant, although some benefits are seen in the lower pressure zones. Below 3000 psig, this cleaning method may not help as much, because fouling at that pressure level is fundamentally different.

Any gaseous alkene may be mixed with ethylene for the purge cleaning composition, but a C3+ hydrocarbon having at least one double bond is preferred. More preferred are C3-C10 alkenes, C3-C8 alkenes, C3-C6 alkenes, C3-C5 alkenes, C3-C4 alkenes, or combinations thereof. For example, the purge cleaning composition can contain propylene, butylene, pentene, hexene, octene, decene, and combinations thereof.

In general, 1-6 mole % of a gaseous C3+ alkene is used in the purge cleaning composition, with the remainder being the ethylene feed gas and other minor components (e.g. ethane and other lights from the production plant) that make up less than 2 vol. % of the purge cleaning composition. In some embodiments, 2-4 mole %, or about 3-4 mole % of the C3+ alkene is used in the purge cleaning composition. In some embodiments, 4 mole % of propylene may be preferred in the purge cleaning composition. Alternatively, 4 mole % (combined total) of propylene, butylene, pentene, hexene, octene, decene, and combinations thereof may be in the purge cleaning composition.

In some embodiments, the purge cleaning composition may also contain minor components such as ethane, and other light hydrocarbon from the system in less than 2.0 vol. % of the purge cleaning composition. If desired, additional chemicals can be added to the purge cleaning composition, such as naptha, benzene, toluene, xylene, or chlorinated solvents such as trichloroethane or trichlorobenzene. However, the advantage of the presently described flush with the purge cleaning composition is that polymeric deposits are completely removed without the use of these toxic chemicals. In addition, only small amounts of the C3+ alkene are needed, and the temperatures and pressures requirements are modest.

The purge cleaning composition described herein is typically performed at reduced temperature and pressure as compared to the polymerization conditions in order to avoid ethylene polymerization, but at high enough temperature and pressure so as to allow the removal of polymer fouling. Thus, pressures and temperatures may be reduced at least 10%, 20% 30%, 40% or 50% or more. Further, the two need not be reduced in lockstep-increases in temperature may be compensated for by decreases in pressure and vice versa. Bench top tests may be performed as described herein in order to optimize the pressure and temperature combinations to remove fouling without causing polymerization.

Generally, pressure is reduced from about 50,000 psig (340 MPa) to about 5,000-25,000 psig (43-172 MPa), 10,000-20,000 psig (69-138 MPa), or about 12,000-18,000 psig (83-124 MPa). Similarly, temperature of the reactor is also reduced to 100-300° F. (37-148° C.), or about 175-225° F. (70-108° C.), or about 195-205° F. (90-97° C.), or about 200-205° F. (93-97° C.). Herein, temperatures were reduced to about 200° F. and pressure was reduced to about 13,000 psig for an autoclave reactor, and to about 17,500 psig for a tubular reactor.

A 6-hour flush with the purge cleaning composition is exemplified herein, but this time frame will vary based on flushing temperature and pressure, the level of C3+ alkene used, as well as on the degree of polymer fouling. In general, the purge cleaning composition is circulated throughout the plant for 2-8 or 4-6 hours. With lower temperature and pressure combinations, the flush may last longer, e.g., 10-12 hours or overnight.

The entire process can require up to 24 hours for a 6 hour flush-4 hours to kill the reactor and get to flush starting conditions, 6 hours for the flush, 12 hours to purge the purge cleaning composition out of the system and 2 hours to light off and restart the reactor. Thus, for improved efficiency, we would like to reduce the flush time as much as possible.

Flush experiments can be conducted as described herein to determine an optimum time period for the flush reaction. Keeping all other conditions the same (e.g., temperature 200° F. and pressure 13,000 psi), a purge cleaning composition with propylene and/or another C3+ alkene can be circulated through a system with polymer fouling for 2, 3, 4, 5, 6 or 8 hours. We anticipate that with 4 mole % of propylene used in each of the flushing experiments, between 4-6 hours of flush time would be optimum for cleaning all the polymer deposits from the system but hope the time may be reduced even further. An optimized time of purge cleaning composition for each site of fouling can thus be determined for a given temperature and pressure.

In addition, these tests can be repeated at various pressure and temperature combinations, and could be repeated for reactor type, instead of line conditions. In this way, optimal time/temperature/pressure conditions can be determined and implemented at a plant for the different equipment types. With optimization, we anticipated that overall plant shutdown time can be reduced to less than 24 hours.

One embodiment of the presently described method is the removal of polymer fouling in a LDPE production plant. Polymerization of ethylene to form LDPE is a high pressure, high temperature reaction. In both autoclave and tubular reactors, LDPE is produced at temperatures ranging from 300 to 660° F. (˜149-350° C.) and at pressures of up to 100-350 MPa (15,000-50,000 psig) on the reactor side and require even higher pressures on the initiator injection lines. At these conditions, about 20% of the ethylene gas is converted to polyethylene. The remaining ethylene is recycled for further use in the polymerization process. To remove polymer fouling in the LDPE production plant, (1) the polymerization reaction can be completely stopped; (2) the temperature of the ethylene-based feed gas is reduced to about 100-300° F. (37-148° C.) or 195-205° F. (90-97° C.); (3) the pressure is reduced to about 5,000-25,000 psig (43-172 MPa) or about 12,000-18,000 psig (83-124 MPa); (4) about 1-6 mole % of at least one C3+ alkene (such as propylene) is added to the ethylene-based feed gas to form a purge cleaning composition; (5) circulating the purge cleaning composition through the plant or at least an area having polymer fouling for 2-8 hours or 4-6 hours; (6) removing or purging the purge cleaning composition from the plant using ethylene-based feed gas, wherein the removed purge cleaning composition contains deposits that were previously fouling the plant; and (7) restarting the polymerization reaction. The total downtime, between stopping and re-starting the polymerization reaction, can be between 6 and 24 hours.

More particularly, the invention includes any one or more of the following embodiments in any combination(s) thereof:

A method of defouling polyethylene (PE) production plants, comprising a) identifying one or more location(s) of polymeric fouling in a polyethylene (PE) production plant; b) stopping the PE polymerization reaction in the system; c) reducing the temperature and pressure of each location with polymeric fouling such that a combined reduced temperature and reduced pressure are less than needed for polymerization of ethylene, but are sufficient for defouling; d) adding a C3+ hydrocarbon having at least one double bond to an ethylene feed gas to produce a purge cleaning composition; e) circulating the purge cleaning composition through the location(s) for a first period of time sufficient for defouling; f) purging the purge cleaning composition from the location(s) with ethylene feed gas for a second period of time, wherein the removed polymeric fouling is in the purge cleaning composition; and g) restarting the PE polymerization reaction in the system to produce PE. Some variation in step order is permitted.

A method of removing polymeric fouling from a low density polyethylene (LDPE) production plant, the method comprising: identifying one or more location(s) of polymeric fouling in an LDPE production plant; stopping an LDPE polymerization reaction in the system; reducing a temperature of the location(s) with polymeric fouling to about 100-300° F. and reducing a pressure of the location(s) to about 10,000-20,000 psig (69-138 MPa); adding 1-6 mole % propylene or C3+ alkene into an ethylene feed gas to produce a purge cleaning composition; circulating the purge cleaning composition through the location(s) for a first period of time sufficient to remove at least 75% of the polymeric fouling; purging the purge cleaning composition from the location(s) with ethylene feed gas for a second period of time; and restarting an LDPE polymerization reaction to produce LDPE.

A method of defouling polyethylene (PE) production plants, comprising a) identifying one or more location(s) of polymeric fouling in a polyethylene (PE) production plant; b) stopping the PE polymerization reaction in the plant, wherein the plant includes a polymerization system containing fouling, wherein the polymeric fouling includes polymeric deposits on surfaces and walls of equipment and lines in a PE production plant; c) reducing the temperature and pressure of each location with polymeric fouling such that a combined reduced temperature and reduced pressure are less than needed for polymerization of ethylene, but are sufficient for defouling, for example reducing pressure to 5,000-25,000 psig (43-172 MPa) and reducing temperature to 100-300° F. (37-148° C.); d) adding a purge cleaning composition to the polymerization system, wherein at least one C3+ alkene is added to an ethylene feed gas to produce the purge cleaning composition purge cleaning composition; e) circulating the purge cleaning composition through the location(s) for a first period of time sufficient for defouling; f) purging the purge cleaning composition from the PE production plant with ethylene feed gas for a second period of time, wherein the removed polymeric fouling is in the purge cleaning composition; and g) restarting the PE polymerization reaction in the system to produce PE.

An improved method of removing polymeric fouling from a polyethylene production plant, the method comprising circulating an aromatic solvent through the system until polymeric fouling is removed, the improvement comprising circulating a purge cleaning composition comprising 1-6 mole percent C3+ alkene in an ethylene feed gas through the system at a temperature and pressure less than needed for polymerization of ethylene, for example a pressure of 5,000-25,000 psig (43-172 MPa) and a temperature of 100-300° F. (37-148° C.), but sufficient for defouling, for a period of time until polymeric fouling is removed, instead of an aromatic solvent.

Any method herein described, wherein the purge cleaning composition has 1-6 mole % of C3+ hydrocarbon having at least one double bond.

Any method herein described, wherein the purge cleaning composition has 2-4 mole % of C3+ hydrocarbon having at least one double bond.

Any method herein described, wherein the reduced temperature is between 150-300° F. (65-148° C.) and the reduced pressure is 10,000-20,000 psig (69-138 MPa).

Any method herein described, wherein the reduced temperature is about 200° F. (93° C.) and the reduced pressure is 12,000-18,000 psig (83-124 MPa).

Any method herein described, wherein the first period of time is about 2-8 hours.

Any method herein described, wherein the first period of time is about 4-6 hours.

Any method herein described, wherein the second period of time is about 1-8 hours.

Any method herein described, wherein the reduced temperature is about 200° F. (93° C.) and the reduced pressure is 12,000-18,000 psig (83-124 MPa) and the first period of time is 4-6 hours.

Any method herein described, wherein the fouled location(s) is one or more of i) a compressor, ii) a cooler, iii) a heater, iv) a reactor, v) a separator, vi) a recycle system, or vii) a piping connecting any of i) to vi).

Any method herein described, wherein the purge cleaning composition is circulated throughout an entirety of the system.

Any method herein described, wherein the C3+ hydrocarbon having at least one double bond is selected from a group comprising C3-C10 alkenes, C3-C8 alkenes, C3-C6 alkenes, C3-C5 alkene, C3-C4 akenes, propylene, butene, pentene, hexene, octene, decene and combinations thereof.

Any method herein described, wherein the C3+ hydrocarbon having at least one double bond comprises propylene.

Any method herein described, wherein the PE is a low density polyethylene production plant.

Any method herein described, wherein the PE is a medium density polyethylene production plant.

The terms ‘fouling’, ‘polymer fouling’, ‘polymeric fouling’ and ‘polymeric deposit’ are used interchangeably and are used to describe polymer deposits (and minor amounts of other built-up material) on the surfaces in a polymer production plant. Fouling can take place on reactor walls, piping connecting various parts of the plant like reactor, compressor, heaters, coolers, etc. Removal of polymer deposits is called “defouling.”

As used herein, ‘flushing’ is a method of removing built-up material (contaminates, chemicals, polymers, debris and others) on equipment and piping in a PE production plant by pumping a composition therethrough. This is typically at elevated temperature and often at elevated pressures, but herein the temperature and pressures are preferably less than that needed for polymerization of ethylene.

As used herein, a ‘purge cleaning composition’ is at least an ethylene gas with up to 6 mole % C3+ hydrocarbon having at least one double bond. The ethylene gas component is the feed gas for the polymerization system. The purge cleaning composition may also have other minor components (e.g. ethane and other lights from the production plant) that make up less than 2 vol. % of the purge cleaning composition.

As used herein, the term ‘melt flow rate’ (MFR) (also called ‘melt index’ (MI) or ‘melt flow index’ (MFI)), refers to the measure of the ease of flow of melted plastic. It is a typical index for quality control for polymers, expressed in g/10 min. The standard test method for determining melt flow rates of thermoplastics is ASTM D1238 (“Standard Test Method for Melt Flow Rates of Thermoplastics by Extrusion Plastometer”), and it is carried out by using an extrusion plastometer. ASTM D1238 measures the melt flow rate at 190° C. for polyethylene and 230° C. for polypropylene, uses 2.16 kg of weight, and is given in gram/10 min. After a specified preheating time, resin is extruded through a die with a specified length and orifice diameter under prescribed conditions of temperature, load, and piston position in the barrel. The ‘melt flow range’ is a range of melt flow rates.

As used herein, the ‘plant’ refers to those portions of the plant that are in fluidic connection and house chemicals, e.g., inside pipelines, tanks, reactors, extruders and the like.

As used herein, the ‘battery limit’ of a process plant refers to the physical boundary of the plant beyond which no process equipment or facilities are considered part of the plant.

All concentrations used herein are in mole percent, unless otherwise specified.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements but allows the inclusions of non-material elements that do not substantially change the nature of the invention, such as instructions for use, buffers, and the like.

Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| HDPE | High density polypropylene |
| HPS | High pressure separator |
| LDPE | Low density polypropylene |
| LPS | Low pressure separator |
| MDPE | Medium density polypropylene |
| MFR | Melt flow rate |
| PE | Polypropylene |
| Pph | Pounds per hour |
| Rxn | Reaction |

### BRIEF DESCRIPTION OF THE DRAWINGS

The FIGURE. A simplified diagram of a typical LDPE production.

### DETAILED DESCRIPTION

Described herein is a method for cleaning an PE production plant to remove polymer fouling. An exemplary schematic of an LDPE production plant is shown in the FIGURE. While variations in LDPE production plants are possible, the present methods can be applied to all system designs and/or orientations.

The LDPE system in the FIGURE contains a 1st compressor 101 (called a primary compressor) which compresses ethylene gas 102 to about 4,500 psig, and a 2nd compressor 103 (called a hyper compressor) to further compress ethylene gas to up to 45,000 psig.

Once sufficiently compressed, the ethylene gas is fed into a reactor (105)—this could be an autoclave or a tubular reactor. The polymerization reaction takes place at about 400-625° F. (˜204-330° C.). Produced polymer travels via high pressure separator (HPS) (109) and low-pressure separator (LPS) (111) into an extruder hopper (113) and then silos (115) for storing in bulk or packaging.

Unreacted gas and gas/polymer mixture is sent from the HPS back to the hyper compressor (103) via circulation lines L-1 and L-2. The gas contaminants are removed in the high pressure recycle (107), and unused gas is compressed to send back into the reactor (105). Unreacted gas and gas/polymer mixture sent from the LPS (111) may be compressed in a booster compressor (117) via circulation L-3. In the booster compressor (117), ethylene gas is separated and fed back into the primary compressor (via L-4), or mixed gases can be vented/purged via L-5.

The presently described defouling methods can be applied to some or all parts of the LDPE production plant exemplified in the FIGURE without having to take the system offline. That is, the flush process can be performed when needed without removing piping and only modest downtime.

### Example 1

A successful test of flush was carried out at a LDPE plant with frequent episodes of polymer fouling in the feed gas line that connects the hyper compressor to the reactor. Fouling was observed in a 60 ft long feed gas line that connects the preheater, consisting of a jacketed high-pressure tubing, and the reactor inlet. The polymer deposit build up would restrict the gas flow to the reactor thereby significantly increasing hyper compressor discharge pressures. Historically, methods of flushing with a naphtha-based solvent through the line removed polymer deposits but required extensive down time to perform the cleaning.

Since the flush with naptha was difficult to perform and time consuming, we tried the presently described flush method using a purge cleaning composition that had propylene as the C3+ alkene. In this example, the purge cleaning composition was about 4 mole % of propylene in the ethylene feed. In more detail, the flush as described below was performed:
1. The LDPE polymerization reaction was completely stopped.
2. Feed gas temperature was decreased to 205° F. (˜96° C.). This was achieved by removing after coolers and introducing steam in preheaters.
3. Reactor pressure was reduced to 13,000 psig (89 MPa).
4. About 4 mole % propylene was added to the feed gas to form the purge cleaning composition (96/4 mole % ethylene/propylene), and this purge cleaning composition was injected into the system.
5. The purge cleaning composition was circulated through the entire system for 6 hours.
6. The purge cleaning composition was then purged with fresh ethylene feed gas.
7. The LDPE polymerization reaction was re-initiated.

The flush started at the discharge of the hyper compressor unit downstream of the preheater, which had the desired temperature and pressure for the polymer removal. However, the entire LDPE plant was circulated with the purge cleaning composition.

At the end of the 6-hour flush period, the deposits were removed as observed by a 50% pressure drop in the line. A visual inspection of the feed line piping was also observed to confirm deposit removal.

Due to the extensive down time for a naptha-flush, the polymer fouling would not be addressed until about six-month post-cleaning. The combined down time of the naptha-flush with the loss of production from narrowed piping would result in an estimated loss of about 500,000 lbs of polymer per month. However, the presently described method can be performed whenever fouling is observed (visibly or by worsening operating conditions) with limited down time and no removal of piping. This resulted in no loss in production being seen for the presently described flush with the purge cleaning composition.

Table 2 provides some additional comparisons between the two methods.

TABLE 2
Comparing naphtha flush and purge cleaning composition.

| | | | Purge cleaning |
|---|---|---|---|
| | Naphtha flush | | composition flush |
| Time period for flushing | 2-4 | days | 6 h |
| Production loss | ~500,000 | lbs/month | No loss. Production on |
| | | | par with the plant |
| | | | output expectation |

### Example 2

The presently described purge cleaning composition was also applied to another site with frequent polymer build-up in two tubular reactors. Fouling inside the reactors was observed by a pressure build-up in different zones in the reactors. A flush was performed with a propylene-containing purge cleaning composition, as described below:
1. Polymerization reaction was completely stopped in the reactors.
2. Feed gas temperature was decreased to 200-210° F. (93-98° C.).
3. Reactor pressure was reduced to 17,500 psig (120 MPa).
4. 2.1 mol % propylene was added to the ethylene feed gas in line 1, and 2.4 mol. % propylene was added to feed gas in line 2. Lines 1 and 2 are independently operated and do not mix in the system.
5. The purge cleaning compositions were circulated throughout for 6 hours.
6. The purge cleaning compositions were then purged with the ethylene feed gas alone.
7. The LDPE polymerization reaction was re-initiated.

While the entire system had one of the purge cleaning compositions, only the hyper interstage, hyper discharge and reactor had the correct pressure and temperature to remove deposits.

Differential pressure before and after the flush in line 1 and line 2 with the purge cleaning compositions were observed to confirm removal of the deposits. Specifically, both lines 1 and 2 showed a 500 psig reduction in the pressure after the flush, indicative of removal of polymer build-up inside the reactors. The polymer production rate after flush in both the reactors was more than pre-flush, indicating that the purge cleaning composition did indeed clean up deposit build-up in the reactor. Detailed results are shown in Table 3.

TABLE 3
Polymer production rate before and after
flush with a purge cleaning composition

| | | | Post-purge |
|---|---|---|---|
| | | Pre-purge cleaning | cleaning |
| | | composition | composition |
| | Propylene | production rate | production rate |
| Reactor | mol. % | (pph) | (pph) |
| Line 1 | 2.1 | 13,218.5 | 14,065.8 |
| Line 2 | 2.4 | 16,131.9 | 16,370.5 |

### Example 3

The inventive method was utilized to clean the fouling in a LDPE plant producing two LDPE polymers. Polymer 1 had an MFR (190° C./2.16 kg) of 1.0 g/10 min, and polymer 2 had an MFR (190° C./2.16 kg) of 2.2 g/10 min. The fouling resulted in a reduction of production rate by about 3000 pph for both polymers.

For this plant, we utilized the above describe processes in Example 2. The propylene concentration in the purge cleaning composition was 2.7 mol %. The purge cleaning composition was circulated through the system for 4-5 hours at 350° F. (177° C.) and 28,300 psig (195 MPa).

As shown in Table 4, removal of the deposit was observed, and both polymer 1 and polymer 2 increased their production rates. The production rate for polymer 1 increased to about 75% of its original level, and the production rate of polymer 2 increased about 110% of its original level.

TABLE 4
Production rate after a flush with a purge cleaning composition

| Polymer | Production rate |
|---|---|
| Polymer 1 | Increase of 2300 pph |
| Polymer 2 | Increase of 3300 pph |

### Example 4

In this next example, in addition to removing typical polymer fouling we demonstrated that we were able to remove residual co-monomer build-ups inside the system and prevent decompositions from the co-monomer. The usual practice of mechanical cleaning, chemical flush, and/or lowering temperatures of certain segments was insufficient to keep this LDPE plant functioning. For this plant, we utilized the above describe processes in Example 2, with an ethylene/propylene mix (96/4 wt. %) for the purge cleaning composition, and conditions of 221-230° F. (105-110° C.) and 13000-14500 psig (89-99 MPa). After 6 hours at the desired conditions, the system was depressurized, the purge cleaning composition was purged with the ethylene feed gas and production resumed after about 10 hours.

With the prior used naptha-flush, fouling was observed about 26 days from the last flush. By contrast, fouling was not observed after the presently described flushing process until about 67 days later. Thus, the fouling rebuilds 2.5 times faster after the naptha-flush compared to the presently described methods. As such, production was stable for extended period of time for over 2 months before a flush with the purge cleaning composition was required. This is a significant improvement over prior operations, where production was interrupted within days or even hours. In addition, the purge cleaning composition was able to remove the build-up between copolymer and homopolymer, and it may be completed between campaigns.

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are each incorporated by reference in its entirety for all purposes:
U.S. Pat. No. 6,644,326 Process for cleaning polymeric fouling from equipment.
US20150075561 Processing for removing polymeric fouling.
ROHMAN, F. S., et al, Nonlinear control of fouling in polyethylene reactors, ACS Omega 7:39648-39661 (2022).
FRIES, S., et al, Fouling in the high pressure LDPE process, Polymer reaction engineering IX (2015), online at https://dc.engconfintl.org/cgi/viewcontent.cgi?article=1002&context=polymer_rx_eng_IX

1. A method of defouling polyethylene (PE) production plants, said method comprising:
a) identifying one or more location(s) of fouling in a polyethylene (PE) production plant;
b) stopping a polyethylene polymerization reaction in said PE production plant, wherein the plant includes a polymerization system containing fouling, wherein the fouling includes polymeric deposits;
c) reducing a temperature of said location(s) to a range of 100-300° F., and reducing a pressure of said location(s) to a range of 5,000-25,000 psig;
d) adding a purge cleaning composition to the polymerization system, wherein the purge cleaning composition comprises 1-6 mol. % of a C3+ hydrocarbon having at least one double bond and ethylene;
e) circulating said purge cleaning composition through at least said one or more location(s) of the PE production plant for a first period of time to remove fouling;
f) purging said purge cleaning composition from at least said location(s) with an ethylene feed gas for a second period of time; and
g) restarting a polyethylene polymerization reaction in said plant to produce PE.

2. The method of claim 1, wherein said purge cleaning composition has 2-4 mole % of said C3+ hydrocarbon having at least one double bond.

3. The method of claim 1, wherein said temperature is 150-300° F. (65-148° C.) and said pressure is 10,000-20,000 psig (69-138 MPa).

4. The method of claim 1, wherein said temperature is about 200° F. (93° C.) and said pressure is 12,000-18,000 psig (83-124 MPa).

5. The method of claim 1, wherein said first period of time is about 2-8 hours.

6. The method of claim 1, wherein said first period of time is about 4-6 hours.

7. The method of claim 1, wherein said temperature is about 200° F. (93° C.) and said pressure is 12,000-18,000 psig (83-124 MPa) and said first period of time is 4-6 hours.

8. The method of claim 1, wherein said location(s) is one or more of i) a compressor, ii) a cooler, iii) a heater, iv) a reactor, v) a separator, vi) a recycle system, or vii) a piping connecting any of i) to vi).

9. The method of claim 1, wherein said purge cleaning composition is circulated throughout an entirety of said PE production plant.

10. The method of claim 1, wherein said C3+ hydrocarbon having at least one double bond is selected from a group comprising C3-C10 alkenes, C3-C8 alkenes, C3-C6 alkenes, C3-C5 alkene, C3-C4 akenes, propylene, butene, pentene, hexene, octene, decene and combinations thereof.

11. The method of claim 1, wherein said C3+ hydrocarbon having at least one double bond comprises propylene.

12. The method of claim 1, wherein said PE production plant is a low density polyethylene production plant or a medium density polyethylene production plant.

13. The method of claim 1, wherein at least 75% of the fouling is removed from the PE production plant.

14. An improved method of removing polymeric fouling from a polyethylene production plant, said method comprising circulating an aromatic solvent through said polyethylene production plant until polymeric fouling is removed, the improvement comprising circulating a purge cleaning composition comprising 2-6 mole percent C3+ hydrocarbon having at least one double bond in an ethylene gas, instead of an aromatic solvent, through said plant for a period of time to remove polymeric fouling, wherein said plant has a temperature and pressure less than needed for polymerization of ethylene.

15. The method of claim 14, wherein said polyethylene production plant is a low density polyethylene production plant or a medium density polyethylene production plant.

16. The method of claim 14, wherein said circulating is at a temperature of about 175-300° F. (79-148° C.) and at a pressure of about 10,000-20,000 psig (69-138 MPa), and said period of time is 2-8 hours.

17. The method of claim 16, wherein said circulating is at about 200° F. (93° C.) and about 12,000-18,000 psig (83-124 MPa) and said period of time is 4-6 hours.

18. A method of removing polymeric fouling from a low density polyethylene (LDPE) production plant, said method comprising:
a) identifying one or more location(s) of fouling in an LDPE production plant, wherein said fouling comprising polymeric deposits;
b) stopping an LDPE polymerization reaction in said plant;
c) reducing a temperature of said location(s) to about 100-300° F. (37-148° C.) and reducing a pressure of said location(s) to about 10,000-20,000 psig (69-138 MPa);
d) adding 1-6 mole % propylene into an ethylene feed gas to produce a purge cleaning solution;
e) circulating said purge cleaning solution through at least said location(s) for a first period of time to remove at least 75% of said fouling;
f) purging said purge cleaning solution from at least said location(s) with fresh ethylene feed gas for a second period of time; and
g) restarting an LDPE polymerization reaction to produce LDPE.

19. The method of claim 18, wherein said location(s) are at a temperature of about 175-225° F. (79-107° C.) and a pressure of about 12,000-18,000 psig (83-124 MPa) and said first period of time is 4-6 hours.
